(19) United States
(12) Patent Application Publication
(10) Pub. No.: US 2009/0305829 A1
(43) Pub. Date: Dec. 10, 2009

(54) Pocket-type sprocket, and chain drive comprising a pocket-type sprocket

(76) Inventors: Rolf Sinz, Heubach (DE); Heribert Herzog, Aalen-Ebnat (DE)

Correspondence Address: Mark P. Stone, 50 Broadway, Hawthorne, NY, 10532, US

(21) Appl. No.: 11/920,217

(22) PCT Filed: May 15, 2006
(86) PCT No.: PCT/EP2006/004859

§ 371 Date: Feb. 27, 2009

(30) Foreign Application Priority Data
May 13, 2005 (DE) 20 2005 007 915.4

(51) Int. Cl. F16H 55/30; F16H 7/18

(52) U.S. Cl. 474/140; 474/164

(57) ABSTRACT

In a pocket-type chain wheel comprising two groups of pockets (3) for chain links (10) of a chain strand which pass through the wheel at an angle α relative to the wheel axis (8), said groups of pockets (3) being disposed next to and offset from each other, the angle α is determined exclusively by the material diameter d and the internal width bᵢ of the chain links (10) at a given number of teeth of the wheel in that it is ensured that the contact between the chain links (10) and the pockets (3) is limited to the area of the flanks of the teeth.

### TECHNICAL FIELD

The present invention relates to a pocket-type chain wheel for chain drives of hoisting devices and lifting apparatuses comprising two groups of pockets for chain links which pass through the wheel at an angle α relative to the wheel axis, said groups of pockets being disposed next to and offset from each other, in which chain wheel the pockets are each defined by a bottom, a side wall, and two teeth-forming transverse webs, and in which the distance A occupied by the side walls of opposing pockets is greater than the extension a of the chain links measured in the direction of the axis of the wheel.

### PRIOR ART

A pocket-type chain wheel of the above type is known from DE 44 06 623 C1. In the known chain wheel the chain links are supported with their legs disposed near the axis on parts of the bottom and with their legs disposed remote from the axis on areas of the transverse webs forming the teeth of the wheel, which areas face said legs remote from the axis, wherein this type of double support defines an angle α the size of which corresponds to the oblique position of the chain links. Moreover, an additional support of the chain links on one of the side walls of the pockets is considered to be of advantage. In other words, this means that in the known chain wheel the size of angle α is determined by the dimensions of the chain wheel, as is also the case with other pertinent pocket-type chain wheels, which are for instance known from U.S. Pat. No. 5,533,938 A. In the chain wheel of the last-mentioned publication, the chain links are supported on the one hand in the area of the transitions of their bows into their legs near the axis on the tooth bases and on the other hand on bearing surfaces of webs, so that the middle planes of the teeth relative to the axis of the wheel occupy a predetermined angle in the order of 45° to 50° in dependence upon the geometry of said wheel (cf. column 2, lines 13-26, loc. cit). A predetermined angle is also occupied by the links of a chain that pass through a chain wheel known from NL 7 904 559 A (=DE 79 18 997 U); the angle is 45° (cf. page 2, line 22). The legs remote from the axis, in contrast to the illustration shown in the incorrect FIG. 2 of said publication, are positioned on the crest of a respective drive tooth (cf. page 2, lines 15-16, loc. cit), whereas the legs near the axis are supported on the respective pocket base. A 45° angle position of the middle plane of the chain link relative to the chain wheel axis or an angular offset of 90° between the middle planes of respectively consecutive chain links of a chain is also accomplished in a chain wheel according to U.S. Pat. No. 662,768 A (cf. page 1, lines 97-102). Angular positions deviating from the 45° angular position of the middle planes of the chain links relative to the respective chain wheel axis are suggested in U.S. Pat. No. 3,415,135 A. However, also in this chain wheel the angular position of the chain links passing through the chain wheel is predetermined by the shape of the chain wheel in dependence upon specific parameters.

As found within the scope of studies, it can be assumed that the loads on the chain links while these are passing through the pocket-type chain wheels according to the four publications first discussed above are smaller than during passage through chain wheels according to U.S. Pat. No. 3,415,135 A. The reason for this might here be that the bottoms of the pockets of the wheels according to the four first-discussed publications are substantially in parallel with and the side walls of the pockets of said wheels are substantially perpendicular to the axis of the wheels so that, in contrast to the conditions prevailing in the chain wheel according to U.S. Pat. No. 3,415,135 A, the chain links have a certain freedom of movement that, however, at great bearing loads does not exclude breakage of the chain before it has reached its replacement state due to wear.

### ILLUSTRATION OF THE INVENTION

However, as has been shown, the loads acting on the chain links can be reduced even further if, in contrast to the solutions that have so far been known, the angle α which is occupied by the chain links while they are running over the chain wheel is not predetermined by the shape of the chain wheel, but if the angle α at a given number of teeth of the wheel depends exclusively on the material diameter d and the internal width bᵢ of the chain links in that it is ensured that the height H of the transverse webs forming the teeth of the wheel is sufficiently small to prevent contact between the longitudinal legs of the chain links which are remote from the axis and the areas of the crests of the teeth formed by the transverse webs, which areas face said longitudinal legs, and that the side walls of the pockets just serve to limit possible movements of the chain links in parallel with the wheel axis.

This means in practice that the chain links while passing through the chain wheel according to the invention occupy an angular position they are so to speak “comfortable with per se” and that they are not exposed to any additional loads resulting from a predetermined forced position. The contact zones via which in the chain wheel according to the invention forces are transmitted between the chain wheel and the links of the chain passing through the chain wheel are limited to the tooth flanks of the transverse webs forming the teeth and the arcuate sections of the chain links abutting on said tooth flanks, the side walls of the pockets just having the function to keep the movements of the chain strand towards the wheel axis within limits without assuming any genuine supporting function. The freedom of movement given to the chain links prevents the formation of critical stresses. Fatigue fractures before the replacement state of the chain has been reached need no longer be feared.

Moreover, the present invention relates to a chain drive equipped with a pocket-type chain wheel according to the invention for a hoisting device or a lifting apparatus wherein the load side and the loose side of the chain strand passing through the pocket-type chain wheel have assigned thereto pivotable guide elements whose pivot axes and the axis of the chain wheel are each positioned in a plane perpendicular to the longitudinal axis of the entering or exiting chain strand. It is the task of the guide elements to stabilize the chain links of the respective chain strand before entry into the pocket-type chain wheel so as to reduce uncontrolled movements, and to ensure a safe entry of the chain strand into the pocket-type chain wheel.

Further features and details of the invention become apparent from the subclaims and the following description of an invention illustrated in the attached drawings.

### BRIEF DESCRIPTION OF THE DRAWINGS

FIG. 1 is a front view of the pockets of a wheel half of a two-part pocket-type chain wheel;

FIG. 2 is a top view on the wheel half according to FIG. 1;

FIG. 3 is a section taken along line, III-III in FIG. 1;

FIG. 4 is a front view of the pocket-type chain wheel consisting of two parts according to FIGS. 1 to 3;

FIG. 5 is a top view on the pocket-type chain wheel according to FIG. 4;

FIG. 6 is a section through a pocket-type chain wheel for a chain the links of which have an internal width bᵢ of 1.1 d;

FIG. 7 is a section through a pocket-type chain wheel for a chain the links of which have an internal width bᵢ of 1.15 d;

FIG. 8 is a section through a pocket-type chain wheel for a chain the links of which have an internal width bᵢ of 1.25 d;

FIG. 9 is a section through a pocket-type chain wheel for a chain the links of which have an internal width bᵢ of 1.3 d;

FIG. 10 is a front view of parts of a chain drive equipped with a round steel chain and having a pocket-type chain wheel according to FIGS. 1 to 9;

FIG. 11 is a top view on the parts of the chain drive according to FIG. 10;

FIG. 12 is a front view of parts of a modified chain drive;

FIG. 13 is a front view of parts of a chain drive equipped with a D-profile chain and having a pocket-type chain wheel according to FIGS. 1 to 9; and

FIG. 14 is a top view on the parts of the chain drive according to FIG. 13.

### WAYS OF CARRYING OUT THE INVENTION

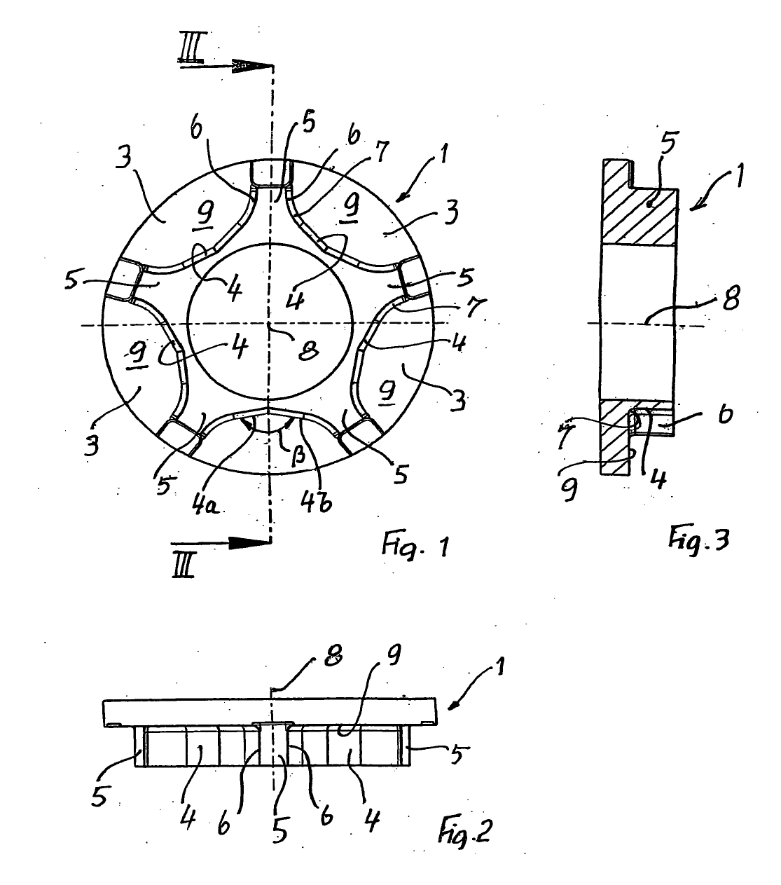

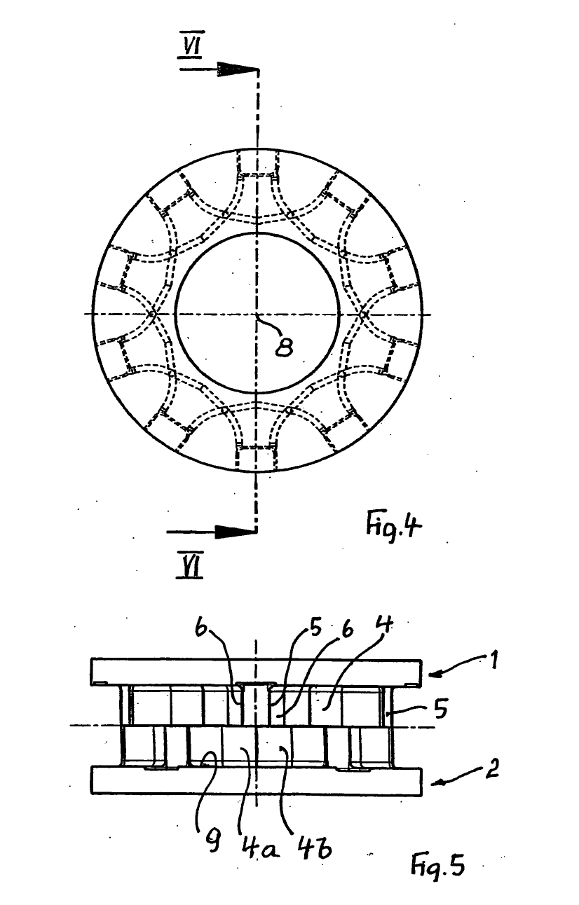

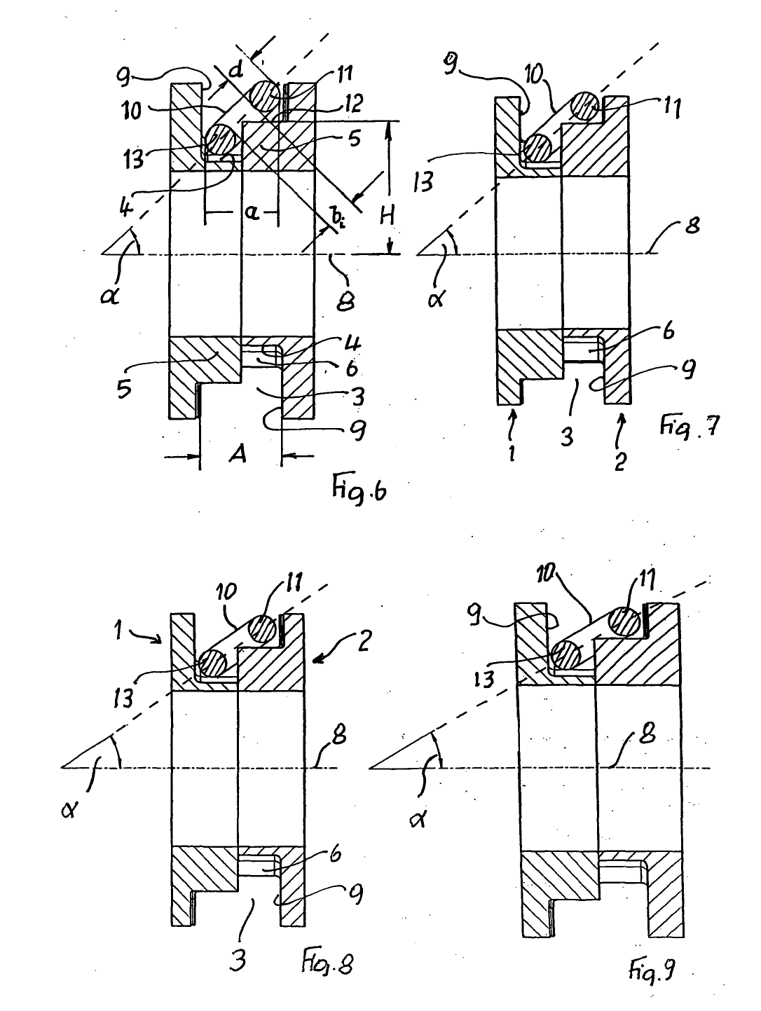

FIGS. 1 and 2 show the two halves of a pocket-type chain wheel that are detachably or undetachably connectable to each other. Each of the two halves forms five pockets 3 the bottoms 4 of which have straight sections 4a and 4b enclosing an angle of about 160° to prevent contact between the weld beads of the chain links and the bottoms 4.

The respectively successive pockets 3 of the pocket rows arranged in offset fashion from one another in the circumferential direction of the wheel are separated from one another by teeth 5 having flanks 6 that serve to transmit forces to the chain links of a chain strand. With the exception of a small transition zone 7 provided for avoiding notch stresses, the bottoms 4 of the pockets 3 and the flanks 6 of the teeth 5 extend in parallel with the axis 8 of the pocket-type chain wheel whereas the side walls 9 of the pockets 3 are oriented perpendicular to the axis 8. At any rate the radius of the transition zones should be smaller than half the diameter d of the links of the chain, with d, in the event that round steel links are used, being the leg diameter and, in the event that D-profile links are used, the diameter of the links that is inscribed into the cross section of the D-profile. In practice, the radius of curvature is in the order of 0.1 d to 0.4 d, so that any contact between the links of the chains and the transition zones is excluded.

FIGS. 6 to 9 show by way of example, each time with reference to a single chain link 10 with a diameter d, which angle α the links of a chain assume in dependence upon their material diameter d and their internal width bᵢ while passing through the pocket-type chain wheel. For instance, the angle α in the case of FIG. 6 is about 45° for a chain having chain links whose internal width bᵢ=1.1 d, whereas it assumes values of about 41° (FIG. 7), about 35° (FIG. 8) and about 30° (FIG. 9) for chain links having internal widths of bᵢ=1.15 d (FIG. 7), bᵢ=1.25 d (FIG. 8) and bᵢ=1.3 d (FIG. 9). As illustrated in FIGS. 6 to 9, the oblique position of the chain links at a given material diameter d and a given number of teeth of the wheel exclusively depends on the internal width bᵢ of the chain links, i.e. in contrast to former standard practice it is not defined by the dimensions of the pocket-type chain wheel, but by the contact conditions prevailing in the bows or link arcs of the interconnected chain links. Under normal conditions it can be assumed that the longitudinal legs 11 of the chain links 10 which are remote from the axis have not only no contact with the areas 12 of the crests of the teeth 5 that face said legs, but in addition that there is also no contact between the opposing side walls 9 of the pockets 3 on the one hand and the longitudinal legs 11 remote from the axis and the longitudinal legs 13 of the chain links 10 near the axis on the other hand. The distance A of the opposing side walls 9 is in other words greater than the external width a of the chain links 10 as measured in the direction of the axis 8. In practice, A should be greater than 1.1 a.

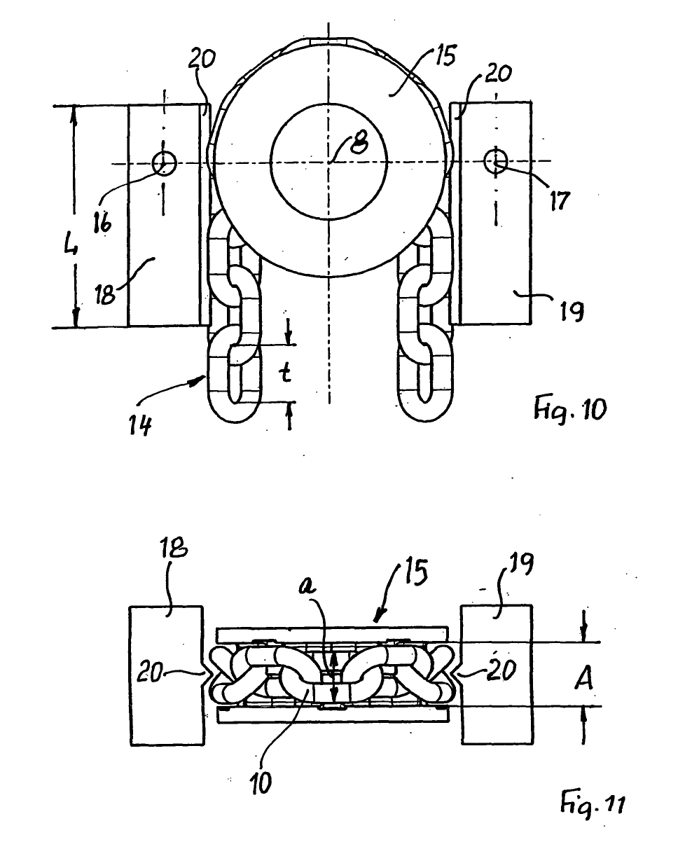

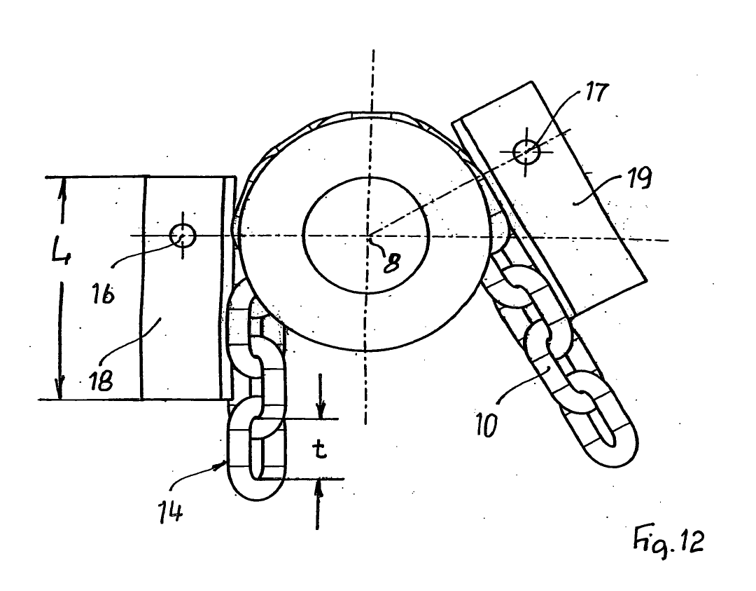

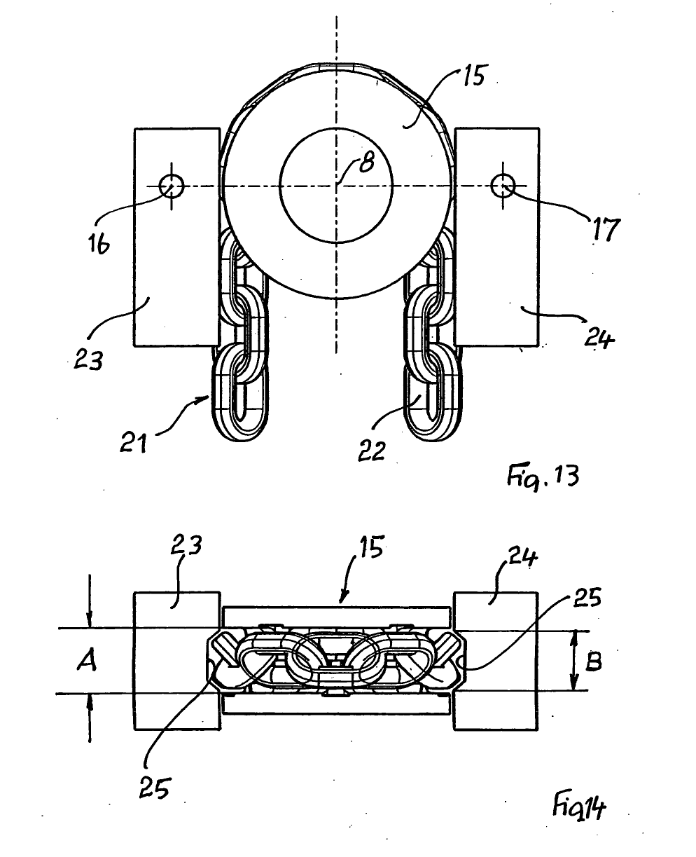

FIGS. 10 and 11 show a pocket-type chain wheel 15 of the above-described type that is wrapped by a chain strand 14 made up of round steel links 10, the chain wheel forming part of a chain drive for a hoisting device or lifting apparatus. The load side and the loose side of the chain strand 14 have assigned thereto two guide elements 18 and 19 that are rotatable about pivot axes 16 and 17, each of the guide elements 18 and 19 comprising guide webs 20 which have a positive effect on the entering and exiting behavior of the chain strand and in addition, as is known per se, counteract a rising movement during entry. As can be seen in FIG. 10, the pivot axes 16, 17 and the axis 8 are positioned in a joint plane perpendicular to the sheet plane. An oblique entry of the chain strand 14 does not mean a joint plane for all of the three axes 8, 16 and 17, but each time a joint plane of the axes 16 and 8 and 17 and 8, respectively, as can be seen from FIG. 12.

Thanks to the pockets 3 of the novel chain wheel that are not adapted to the shape of the chain links 10, it is easily possible to exchange a chain strand 14 made up of round steel links 10 for a chain strand 21 made up of D-profile links 22. Especially when a chain strand 21 of D-profile links 22 is used, it turns out to be expedient, as shown in FIGS. 13 and 14, to replace the guide elements 18 and 19 by guide elements 23, 24 in the case of which a guide groove 25 is provided instead of a guide web 20. The maximal width B of the guide groove 25 has deliberately been chosen to be smaller than the distance A between the side walls 9 of the pockets 3 so as to ensure, like in the case of the solution according to FIGS. 10 to 12, a centric entry of the chain links 22 into the pocket-type chain wheel 15.

As a rule, it is possible to omit guide webs and guide grooves. In this case, too, the side walls 9 of the pockets 3 prevent lateral traveling movements of the chain strand passing through the wheel, which traveling movements extend in parallel with the wheel axis 8, without forcing the chain links into an “angular straightjacket” predetermined by the chain wheel.

1. A pocket-type chain wheel for chain drives of hoisting devices and lifting apparatuses comprising two groups of pockets (3) for chain links (10; 22) which pass through the wheel at an angle α relative to the wheel axis (8), said groups of pockets (3) being disposed next to and offset from each other, in which chain wheel the pockets (3) are each defined by a bottom (4), a side wall (9), and two teeth (5)-forming transverse webs, and in which the distance A occupied by the side walls (9) of opposing pockets (3) is greater than the extension a of the chain links (10; 22) measured in parallel with the direction of the axis (8) of the wheel, characterized in that the angle α at a given number of teeth of the wheel depends exclusively on the material diameter d of the chain links and the internal width bᵢ of the chain links (10; 22) in that it is ensured that the height H of the transverse webs forming the teeth (5) of the wheel is sufficiently small to prevent contact between the longitudinal legs (11) of the chain links (10; 22) which are remote from the axis and the areas (12) of the crests of the teeth (5) formed by the transverse webs, which areas (12) face the longitudinal legs, and that the side walls (9) of the pockets (3) just serve to limit possible movements of the chain links (10; 22) in parallel with the wheel axis (8).

2. The pocket-type chain wheel according to claim 1, characterized in that the distance (A); occupied by the side walls (9) of opposing pockets (3) is greater than 1.1 times the extension (a) of the chain links (10; 22), measured in the direction of the axis (8) of the wheel.

3. The pocket-type chain wheel according to claim 1, characterized in that the bottoms (4) of the pockets (3) for avoiding contact between them and the longitudinal legs (13) of the chain links (10; 22) which face the same and are near the axis consist of two sections (4a, 4b) which enclose an obtuse angle β with each other and whose ends facing away from each other pass into the flanks (6) of the teeth of the wheel.

4. The pocket-type chain wheel according to claim 1, characterized in that the bottoms (4) of the pockets (3) extend in parallel with the axis (8) and the side walls (9) of the pockets (3) extend perpendicular to the axis (8) of the wheel.

5. The pocket-type chain wheel according to claim 4, characterized in that the flanks (6) of the teeth (5) and the bottoms (4) of the pockets (3) pass via curved zones (7) with a radius into the side walls (9) of the pockets (3), which radius is sufficiently small to exclude any contact between said zones (7) and the chain links (10; 22).

6. The pocket-type chain wheel according to claim 1, characterized in that the transition zones (7) between the flanks (6) of the teeth (5) and the bottoms (4) of the pockets (3) on the one hand and the side walls (9) thereof on the other hand have a radius of not more than 0.4 d.

7. A chain drive comprising a pocket-type chain wheel according to claim 1, characterized in that the load side and the loose side of the chain strand (14; 21) passing through the pocket-type chain wheel (1, 2) have assigned thereto pivotable guide elements (18, 19; 23, 24) whose pivot axes (16, 17) and the axis (8) of the chain wheel are each positioned in a plane perpendicular to the longitudinal axis of the entering or exiting chain strand (14; 21).

8. The chain drive according to claim 7, characterized in that the guide elements (18, 19; 23, 24) comprise guide webs (20) or guide grooves (25) the length L of which is at least 2.5 times pitch t of the chain links (10; 22) of the chain strand (14; 21).

9. The chain drive according to claim 7, characterized in that the guide elements (18, 19; 23, 24) comprise one section positioned below and one section positioned above the pivot axis (16, 17) thereof, of which the lower section has a length at least two times the chain pitch.

10. The chain drive according to claim 7, characterized in that the links (10; 22) of the chain strand (14; 21) have an internal width bᵢ of 1.1 to 1.4 d.

11. The pocket-type chain wheel according to claim 2, characterized in that the bottoms (4) of the pockets (3) for avoiding contact between them and the longitudinal legs (13) of the chain links (10; 22) which face the same and are near the axis consist of two sections (4a, 4b) which enclose an obtuse angle β with each other and whose ends facing away from each other pass into the flanks (6) of the teeth of the wheel.

12. The chain drive according to claim 8, characterized in that the guide elements (18, 19; 23, 24) comprise one section positioned below and one section positioned above the pivot axis (16, 17) thereof, of which the lower section has a length at least two times the chain pitch.

13. The pocket-type chain wheel according to claim 2, characterized in that the bottoms (4) of the pockets (3) extend in parallel with the axis (8) and the side walls (9) of the pockets (3) extend perpendicular to the axis (8) of the wheel.

14. The pocket-type chain wheel according to claim 3, characterized in that the bottoms (4) of the pockets (3) extend in parallel with the axis (8) and the side walls (9) of the pockets (3) extend perpendicular to the axis (8) of the wheel.

15. The pocket-type chain wheel according to claim 2, characterized in that the transition zones (7) between the flanks (6) of the teeth (5) and the bottoms (4) of the pockets (3) on the one hand and the side walls (9) thereof on the other hand have a radius of not more than 0.4 d.

16. The pocket-type chain wheel according to claim 3, characterized in that the transition zones (7) between the flanks (6) of the teeth (5) and the bottoms (4) of the pockets (3) on the one hand and the side walls (9) thereof on the other hand have a radius of not more than 0.4 d.

17. A chain drive comprising a pocket-type chain wheel according to claim 2, characterized in that the load side and the loose side of the chain strand (14; 21) passing through the pocket-type chain wheel (1, 2) have assigned thereto pivotable guide elements (18, 19; 23, 24) whose pivot axes (16, 17) and the axis (8) of the chain wheel are each positioned in a plane perpendicular to the longitudinal axis of the entering or exiting chain strand (14; 21).

18. A chain drive comprising a pocket-type chain wheel according to claim 3, characterized in that the load side and the loose side of the chain strand (14; 21) passing through the pocket-type chain wheel (1, 2) have assigned thereto pivotable guide elements (18, 19; 23, 24) whose pivot axes (16, 17) and the axis (8) of the chain wheel are each positioned in a plane perpendicular to the longitudinal axis of the entering or exiting chain strand (14; 21).

19. The chain drive according to claim 8, characterized in that the links (10; 22) of the chain strand (14; 21) have an internal width bᵢ of 1.1 to 1.4 d.

20. The chain drive according to claim 9, characterized in that the links (10; 22) of the chain strand (14; 21) have an internal width bᵢ of 1.1 to 1.4 d.
